(19) United States
(12) Patent Application Publication
(10) Pub. No.: US 2004/0040117 A1
(43) Pub. Date: Mar. 4, 2004

(54) Ejector handle

(75) Inventors: Jim Purcell, Brentwood, CA (US); Todd McDonough, Oakley, CA (US); Grant Kiba, Brentwood, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Purcell Brackets, Inc., Brentwood, CA

(21) Appl. No.: 10/236,052

(22) Filed: Sep. 4, 2002

(51) Int. Cl. E05F 1/08

(52) U.S. Cl. 16/277

(57) ABSTRACT

An ejector handle is disclosed. In one embodiment, the ejector handle includes a handle and a latch button coupled to the handle. The latch button has a first end portion and a second end portion, and is adapted to pivot about an axis between the first end portion and the second end portion. A biasing device is in the ejector handle and is adapted to bias the latch button when the latch button is in a latched state.

### FIELD OF INVENTION

Embodiments of the invention relate to ejector handles, particularly ejector handles that are used in plug-in units with circuit boards.

### BACKGROUND OF INVENTION

Systems using a printed circuit board card cage (also referred to as a “chassis”) are known. A typical card cage includes a pair of spaced card guides for slidably receiving the opposite edges of a printed circuit board. The card cage can have a motherboard (or “backplane”) associated with it. The motherboard has an electrical connector that is interconnected with an electrical connector on the printed circuit board. The printed circuit board is removably connected to the motherboard through the electrical connector. The end of the printed circuit board that is opposite to the end mounted to the motherboard is secured to a bracket (sometimes referred to as an “input/output bracket”). Ejector handles are on the bracket so that the user can pull the circuit board out of the card cage if the circuit board needs to be replaced. The combination including the circuit board, bracket, and ejector handles is referred to in the art as a “plug-in unit”.

The gripping action provided by the two interconnected electrical connectors, namely, the connector on the printed circuit board and the electrical connector associated with the motherboard, makes it difficult to remove the plug-in unit from the card cage. One or two ejector handles are mounted on the bracket of the plug-in unit so that the plug-in unit can be manually pulled from the card cage. In the card cage, a common surface is conventionally provided adjacent the bracket of the plug-in unit to function as a fixed ejection surface for any ejector handle mounted to the bracket. Present day ejector handles are mounted on the front face of the bracket of the plug-in unit. The plug-in unit is extracted from the card cage upon the application of a pivoting force applied to the ejector handle that is transmitted against the fixed ejection surface to provide the extraction action.

Although conventional ejector handles in plug-in units are adequate, a number of improvements could be made. First, an individual can accidentally contact the ejector handles. If this happens, the plug-in unit with the ejector handles could accidentally eject from the card cage. If this happens, the computer system using the plug-in unit may unintentionally shut down. Second, individuals that interact with the plug-in units may build up static electricity. If a statically charged individual contacts the plug-in unit, the static electricity could pass to the plug-in unit and potentially damage electrical components associated with the plug-in unit. It would be desirable if an ejector handle could direct any static charges away from the electrical components to reduce the likelihood of damage to the system. Third, it would be desirable to make the ejector handle easier to operate than conventional ejector handles. Current ejector handles are difficult to operate and uncomfortable for the user.

Embodiments of the invention address these problems, individually and collectively.

### SUMMARY OF INVENTION

Embodiments of the invention include ejector handles and plug-in units that include ejector handles.

One embodiment of the invention is directed to an ejector handle comprising: a handle; a latch button having a first end portion and a second end portion, wherein the latch button is adapted to pivot about an axis between the first end portion and the second end portion; and a biasing device such as a spring is adapted to bias the latch button when the latch button is in a latched state.

Another embodiment of the invention is directed to a plug-in unit comprising: a circuit board; a bracket at an edge of the circuit board, wherein the bracket has a first end and a second end; a first ejector handle at the first end of the bracket; and an optional second ejector handle at the second end of the bracket, wherein the first and the optional second ejector handles each include (i) a handle, (ii) a latch button having a first end portion and a second end portion, wherein the latch button is adapted to pivot about an axis between the first end portion and the second end portion; and (iii) a biasing device such as a spring is adapted to bias the latch button when the latch button is in a latched state.

Another embodiment of the invention is directed to an ejector handle comprising: a handle; a latch button having a first end portion and a second end portion, wherein the latch button is adapted to pivot about an axis between the first end portion and the second end portion; a biasing device adapted to bias the latch button when the latch button is in a latched state; a hinge block; a handle pin coupling the hinge block and the handle, wherein the handle pin permits the handle to move independently of the hinge block; and a guide pin extending from the hinge block, wherein the latch button, the hinge block, and the guide pin each comprise a conductive material and provide a path from a user in contact with the latch button to the guide pin.

These and other embodiments of the invention are described in further detail below.

### BRIEF DESCRIPTION OF THE DRAWINGS

FIG. 1(a) shows a side cross-sectional view of an ejector handle according to an embodiment of the invention when it is in a closed, latched state. A hot-swap, micro-switch device in the ejector handle is not active.

FIG. 1(b) shows a side cross-sectional view of an ejector handle according to an embodiment of the invention when it is in a closed, unlatched state, but where a hot-swap, micro-switch in the ejector handle is activated.

FIG. 1(c) shows a side cross-sectional view of an ejector handle according to an embodiment of the invention when it is in a closed, latched state. The cross-section is at a different plane than the cross-sectional view shown in FIG. 1 (a).

FIG. 1(d) shows a side cross-sectional view of an ejector handle according to an embodiment of the invention when it is in an open position.

FIG. 2 shows a perspective view showing a plug-in unit, as it would be present in a card cage.

### DETAILED DESCRIPTION

Ejector handles are disclosed. In one embodiment, the ejector handle includes a handle and a latch button coupled to the handle. The latch button has a first end portion and a second end portion, and is adapted to pivot about an axis between the first end portion and the second end portion. A biasing device is in the ejector handle and is adapted to bias the latch button when the latch button is in a latched state. Embodiments of the invention can be used, for example, in plug-in units in large and small computer systems.

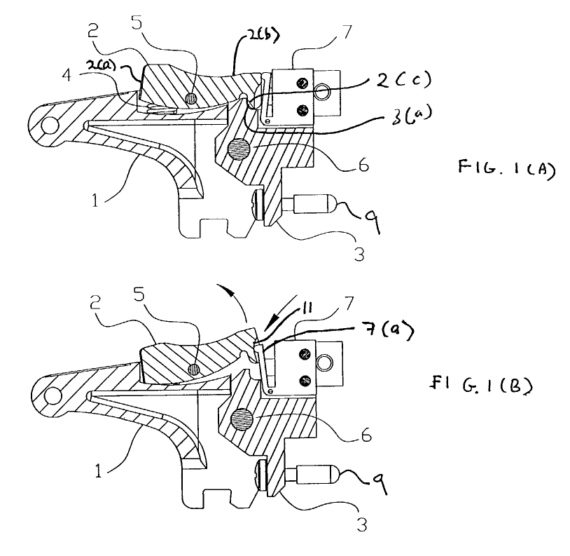

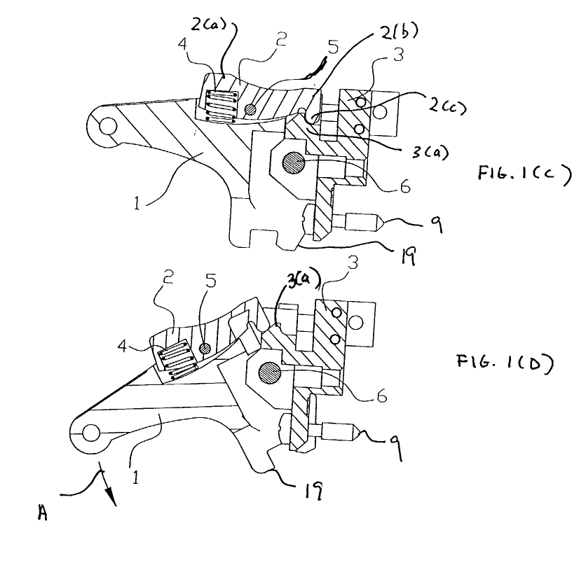

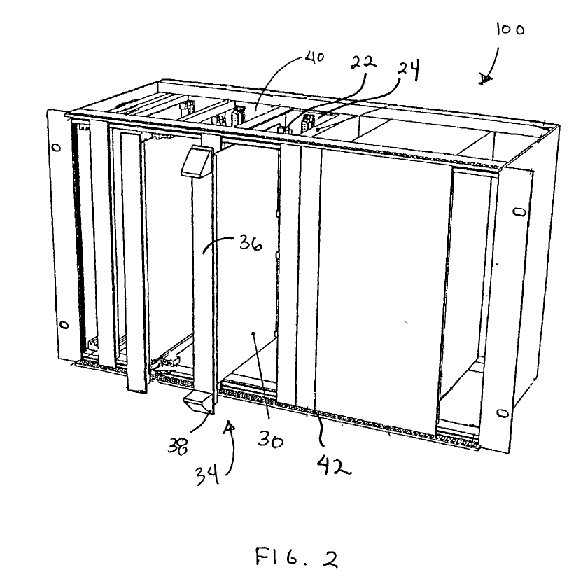

FIGS. 1(a)-1(d) show an ejector handle according to an embodiment of the invention. The ejector handle is shown in different operational positions (briefly described above). In FIGS. 1(a)-1(d), like elements are designed by like numerals.

FIG. 1(a) shows an ejector handle including a handle 1 coupled to a hinge block 3 through a handle pin 6. The handle 1 could be made of any suitable material including metal, or molded plastic. A hot-swap, micro-switch device 7 is adjacent to and coupled to the hinge block 3. The hinge block 3 is preferably made of a conductive material such as a conductive metal. For example, the hinge block 3 may comprise a plated metal such as nickel plated metal such as nickel-plated zinc.

A latch button 2 having a first end portion 2(a) and a second end portion 2(b) is coupled to the handle 1 via a latch pin 5. The latch pin 5 may define an axis about which the first and second end portions 2(a), 2(b) may pivot so that the latch button 2 can move independently of the hinge block 3. The latch button 2 and the latch pin 5 are also preferably made of a conductive material such as a conductive metal. In this example, the orientation of the latch button 2 is generally parallel to the orientation of the handle 1. In the illustrated example, the hinge block 3 is proximate to the second end portion 2(b) of the latch button 2.

A biasing device 4 (preferably a spring) is under the first end portion 2(a) and biases the first end portion 2(a) upward so that the latch button 2 is in a latched state. As shown in FIG. 1(a), the latch button 2 includes a latching portion 2(c) in the second end portion 2(b) that latches onto a latching portion 3(a) in the hinge block 3. When the ejector handle is in a latched state, the handle 1 cannot freely pivot about the handle pin 6. In this example, the biasing device 4 is a spring that fits within a recess at the underside of the first end portion 2(a) of the latch button 2. The biasing device 4 could alternatively be an elastomeric or resilient material.

When force is not exerted downward on the first end portion 2(a), the first end portion 2(a) is biased upward by the biasing device 4. To unlatch the latching portions 2(c), 3(a) of the latch button 2 and the hinge block 3, the user can use the user's thumb to depress the first end portion 2(a) of the latch button 2 to push it down. The latch button 2 pivots about the latch pin 5 and can “rock”. The rocking action of the latch button 2 makes the ejector handle easier to operate than conventional ejector handles. The curved latch button 2 also makes the ejector handle more ergonomic and more comfortable than conventional ejector handles.

A guide pin 9 extends away from the hinge block 3. The guide pin 9 may be also referred to as an electrostatic discharge pin. The guide pin 9 may be electrically coupled to a card cage (not shown), which is at ground.

In embodiments of the invention, the latch button 2, the hinge block 3, and the guide pin 9 may provide a conductive path to ground. The conductive path allows static charge that may be in a user to pass to the card cage, which is at ground. This advantageously prevents the static discharge from reaching any electrical components on the circuit board in the plug-in module. As noted above, static electricity can harm electrical components on the circuit board.

A hot-swap, micro-switch device 7 is coupled to the hinge block 3. It is also in contact with the second end portion 2(b) of the latch button 2. Once the movement of the handle 1 activates the micro-switch device 7, it is possible to “hot-swap” a plug-in unit that has the illustrated ejector handle.

Data and network communication systems typically require a long up time when initialized. This is particularly true when a large number of logic boards are connected and integrated into the system. Conventionally, to insert or remove a circuit board from the system motherboard, the system would ordinarily be first powered down before insertion or removal of the circuit board. This has been necessary to avoid the sudden making or breaking of circuit connections, which tends to generate electrical noise on the motherboard power bus and causing errors on the data bus. The reconfiguration and initialization of the system results in long and inconvenient system downtime. The hot-swap, micro-switch device 7 allows for the live-insertion of a circuit board into a card cage without damaging the system, or interfering with data communications of the system. The hot-swap, micro-switch device 7 does this, by informing the circuit board early (i.e., before it is actually pulled out) that the circuit board will be pulled out of the card cage.

In embodiments of the invention, the hot-swap, micro-switch device 7 can activate independently of the rotation of the handle 1. FIG. 1(b) shows the hot-swap, micro-switch device 7 being activated when a user uses the user's thumb to press down on the first end portion 2(a) of the handle 2. The first end portion 2(a) moves in a direction that is opposite to the direction of bias provided by the biasing device 4. As the user presses the first end portion 2(a) down against the biasing force provided by the biasing device 4, the second end portion 2(b) pivots upward so that the hot-swap, micro-switch device 7 is activated. In this example, a biased actuator arm 7(a) of the hot-swap, micro-switch device 7 is outwardly biased and enters a space defined by a concave surface 11 at the end face of the first end portion 2(a) of the latch button 2. As shown in FIG. 1(b), the hot-swap, micro-switch device 7 is activated, even though the handle 1 has not moved. The early activation of the hot-swap, micro-switch 7 informs the circuit board (not shown) that is attached to the ejector handle (or the system which includes the circuit board) that settings on the circuit board should be saved as the circuit board is about to be pulled out of the card cage. Typically, a circuit board needs about 3 or 4 seconds of rest, before it can be shut down. The hot-swap, micro-switch device 7 allows the circuit board to have this rest before it is removed from the card cage.

FIGS. 1(c) and 1(d) show the movement of the handle 1. FIG. 1(c) shows the ejector handle in a closed state, while FIG. 1(d) shows the ejector handle in an open state. As shown in FIG. 1(c), in a latched state, the first end portion 2(a) of the latch button 2 is biased upward with the biasing device 4. A user may press down on the first end portion 2(a) to unlatch the latching portion 2(c) in the second end portion 2(a) of the latch button 2 from the latching portion 3(a) of the hinge block 3. Once they are unlatched from each other, the user may then freely rotate the handle 1 (in this example counter-clockwise) so that the user can pull out the circuit board (not shown) attached to the ejector handle.

The handle 1 does not move unless the user actuates the latch button 2. Since the latch button 2 is disposed inward from the edges of the ejector handle, the latch button 2 is unlikely to be accidentally contacted by a person. That is, even if a person accidentally contacts the handle 1, the handle 1 does not unlatch from the hinge block 3 and the handle 1 does not move. Consequently, it is unlikely that a plug-in unit with the ejector handles will accidentally eject from a card cage, since the ejection of the plug-in unit is dependent on the movement of the handle 1. As noted above, accidental ejection of the plug-in unit can be problematic as the accidental removal of a circuit board from a larger system could disrupt and/or damage the operation of the system as a whole.

The handle 1 includes an ejection portion 19 that contacts a portion of a stationary card cage (not shown) when the handle 1 rotates in the direction of the arrow A. When the ejection portion 19 contacts the portion of the card cage, the circuit board, which is secured to the ejector handle, is withdrawn from the card cage. The plug-in unit, which has the ejector handle, can then be removed.

FIG. 2 shows an exemplary system 100 in which the ejector handles according to embodiments of the invention can be used. As shown in FIG. 2, a plug-in unit 34 may include a bracket 36, and two ejector handles 38 (the detail of the ejector handles is omitted in FIG. 2 for clarity of illustration) at opposite ends of the bracket 36. The bracket 36 and the ejector handles 38 are attached to a circuit board 30. A first electrical connector 22 is attached to the circuit board 30. The first electrical connector 22 can be electrically coupled to a second electrical connector 24, which is attached to a motherboard 40. In this example, the motherboard 40 and the circuit board 30 are generally perpendicular to each other. A card cage 42 houses the plug-in unit 34 and other plug-in units. The card cage 42 is typically at ground.

It is understood that the ejector handles according to embodiments of the invention could be used in other environments. For example, the ejector handles according to embodiments of the invention could be used with input/output brackets used on smaller personal computers.

Embodiments of the invention provide a number of advantages. First, as noted above, it is unlikely that the ejector handles according to embodiments of the invention will accidentally unlatch due to accidental contact by a person. This reduces the possibility of accidental damage to the system due to the accidental ejection of the plug-in unit from a card cage. Second, the ejector handles according to embodiments of the invention ground the user so that static discharges from the user do not damage electrical components in a plug-in unit. Third, embodiments of the invention use a hot-swap, micro-switch. The hot-swap micro-switch can inform a circuit board to which the ejector handle is attached that it needs to shut down. This can also prevent inadvertent damage to the system. Fourth, the latch button in the ejector handles according to embodiments of the invention is ergonomic and is comfortable for the user to use. Thus, embodiments of the invention provide for a unique combination of advantages.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. For example, although components such as the handle are illustrated as one integral unit, it would be two or more components coupled together in some embodiments.

What is claimed is:

1. An ejector handle comprising:
a handle;
a latch button having a first end portion and a second end portion, wherein the latch button is adapted to pivot about an axis between the first end portion and the second end portion; and
a biasing device adapted to bias the latch button when the latch button is in a latched state.

2. The ejector handle of claim 1 further comprising:
a hot-swap, micro-switch device in contact with the second end portion of the latch button.

3. The ejector handle of claim 1 further comprising:
a hinge block proximate the second end portion of the latch button and distal to the first end portion of the latch button.

4. The ejector handle of claim 1 further comprising:
a hinge block proximate the second end portion of the latch button and distal to the first end portion of the latch button; and
a guide pin extending from the hinge block.

5. The ejector, handle of claim 1 further comprising:
a hinge block proximate the second end portion of the latch button and distal to the first end portion of the latch button; and
a guide pin extending from the hinge block,
wherein each of the hinge block, the guide pin, and the latch button comprises a conductive material.

6. The ejector handle of claim 1 further comprising:
a hot-swap, micro-switch device in contact with the second end portion of the latch button, and wherein the second end portion of the latch button includes a concave surface adapted to receive a portion of the hot-swap, micro-switch device when the latch button is depressed by the user.

7. The ejector handle of claim 1 further comprising:
a hinge block proximate the second end portion of the latch button and distal to the first end portion of the latch button; and
a latch pin coupling the latch button and the handle, wherein the latch pin permits the latch button to move independently of the handle.

8. An ejector handle comprising:
a handle;
a latch button having a first end portion and a second end portion, wherein the latch button is adapted to pivot about an axis between the first end portion and the second end portion;
a biasing device adapted to bias the latch button when the latch button is in a latched state;
a hinge block;
a handle pin coupling the hinge block and the handle, wherein the handle pin permits the handle to move independently of the hinge block; and
a guide pin extending from the hinge block,
wherein the latch button, the hinge block, and the guide pin each comprise a conductive material and provide a conductive path from a user in contact with the latch button to the guide pin.

9. The ejector handle of claim 8 further comprising a hot-swap, micro-switch device coupled to the hinge block and in contact with the second end portion of the latch button, and wherein the biasing device is a spring.

10. The ejector handle of claim 8 wherein the handle comprises plastic.

11. A plug-in unit comprising:
a circuit board;
a bracket at an edge of the circuit board, wherein the bracket has a first end and a second end;
a first ejector handle at the first end of the bracket; and
an optional second ejector handle at the second end of the bracket,
wherein the first ejector handle and the optional second ejector handle each include (i) a handle, (ii) a latch button having a first end portion and a second end portion, wherein the latch button is adapted to pivot about an axis between the first end portion and the second end portion; and (iii) a biasing device adapted to bias the latch button when the latch button is in a latched state.

12. The plug-in unit of claim 11 wherein each ejector handle includes a hot-swap, micro-switch device in contact with the second end portion of the latch button.

13. The plug-in unit of claim 11 wherein each ejector handle includes a hinge block proximate the second end portion of the latch button and distal to the first end portion of the latch button.

14. The plug-in unit of claim 11 wherein each ejector handle further includes a hinge block proximate the second end portion of the latch button and distal to the first end portion of the latch button; and
a guide pin extending from the hinge block.

15. The plug-in unit of claim 11 wherein each ejector handle further comprises:
a hinge block proximate the second end portion of the latch button and distal to the first end portion of the latch button; and
a guide pin extending from the hinge block,
wherein each of the hinge block, the guide pin, and the latch button comprise a conductive material.

16. The plug-in unit of claim 11 wherein each ejector handle includes:
a hot-swap, micro-switch device in contact with the second end portion of the latch button, and wherein the second end portion of the latch button includes a concave surface adapted to receive a portion of the hot-swap, micro-switch device when the latch button is depressed by the user.

17. The plug-in unit of claim 11 wherein each ejector handle further comprises:
a hinge block proximate the second end portion of the latch button and distal to the first end portion of the latch button; and
a handle pin coupling the hinge block and the handle, wherein the handle pin permits the handle to move independently of the hinge block.
